(19) United States
(12) Patent Application Publication
(10) Pub. No.: US 2026/0282015 A1
(43) Pub. Date: Sep. 17, 2026

(54) METHODS, DEVICES, AND STORAGE MEDIA FOR INFORMATION SENDING, AND INFORMATION RECEIVING

(71) Applicant: ZTE Corporation, Shenzhen (CN)

(72) Inventor: Liquan YUAN, Shenzhen (CN)

(21) Appl. No.: 19/674,779

(22) Filed: May 12, 2026

Related U.S. Application Data
(63) Continuation of application No. PCT/CN2024/097718, filed on Jun. 6, 2024.

(30) Foreign Application Priority Data
Nov. 13, 2023 (CN) 202311515253.8

(51) Int. Cl. H04W 72/20; H04B 17/318; H04W 72/0446; H04W 72/0453; H04W 72/51

(52) U.S. Cl. CPC H04W 72/20; H04B 17/318; H04W 72/0446; H04W 72/0453; H04W 72/51

(57) ABSTRACT

This application provides methods, devices, and storage media for information sending, and information receiving. The information sending method includes: acquiring, by a first device, characteristic information of a non-Wi-Fi signal, and then sending, by the first device, a first frame carrying the characteristic information of the non-Wi-Fi signal to a second device, to cause the second device to perform channel configuration related operations according to the characteristic information of the non-Wi-Fi signal.

### CROSS-REFERENCE TO RELATED APPLICATION(S)

This application is a continuation of International Patent Application No. PCT/CN2024/097718, filed on Jun. 6, 2024, which claims priority to Chinese patent application No. 202311515253.8, filed on Nov. 13, 2023. The entire contents of the before-mentioned patent applications are incorporated by reference as part of the disclosure of this application.

### FIELD

This application relates to the field of communication technology, and in particular, to methods, devices, and storage media for information sending, and information receiving.

### BACKGROUND

At present, various countries or regions have set corresponding electromagnetic wave frequency bands for industrial, scientific, and medical fields, which are called industrial scientific medical (ISM) bands. The ISM band is an unlicensed or license-exempt frequency band, meaning no need to apply for a license from a dedicated authority to utilize it.

In view of the license-exempt use of the ISM band, products employing other non-Wi-Fi communication technologies also use the same ISM band. Products such as a Bluetooth device, a ZigBee device, a wireless telephone, and a microwave oven, all utilize the ISM band. Therefore, when the Wi-Fi technology is first applied, there is a possibility of conflict with spectrum resources of other wireless products.

The rapid growth in types and quantities of Wi-Fi products is largely attributed to the license-exempt frequency band as a key factor. However, after the large-scale popularization of Wi-Fi, the use of wireless resources in the license-exempt frequency band by devices causes more and more conflicts, and the signal interference between the devices in turn has become the constraint of the application of Wi-Fi technology in scenarios. Therefore, how to reduce the signal interference when the device uses Wi-Fi communication has become an urgent technical problem to be solved in the field.

### SUMMARY

In a first aspect, an embodiment of this application provides an information sending method. The method includes: acquiring, by a first device, characteristic information of a non-Wi-Fi signal; and sending, by the first device, a first frame to a second device, the first frame carrying the characteristic information of the non-Wi-Fi signal to cause the second device to perform channel configuration related operations according to the characteristic information of the non-Wi-Fi signal.

In a second aspect, an embodiment of this application provides an information receiving method. The method includes: receiving, by a second device, a first frame sent by a first device, the first frame carrying characteristic information of a non-Wi-Fi signal; and performing channel configuration related operations according to the characteristic information of the non-Wi-Fi signal.

In a third aspect, an embodiment of this application provides an electronic device, including one or more processors; and a memory, having one or more programs stored thereon. The one or more programs, when executed by the one or more processors, cause the one or more processors to implement the information sending method in the first aspect or the information receiving method in the second aspect.

In a fourth aspect, an embodiment of this application provides a computer-readable storage medium, having a computer program stored thereon. The computer program, when executed by a processor, causes the information sending method in the first aspect to be implemented or the information receiving method in the second aspect to be implemented.

### BRIEF DESCRIPTION OF THE DRAWINGS

The accompanying drawings are used to provide a further understanding of technical solutions of this application, and constitute a part of this specification, which are used to explain the technical solutions of this application in conjunction with the embodiments of this application, and do not constitute a limitation to the technical solutions of this application.

FIG. 1A illustrates a schematic diagram of a network architecture according to an embodiment of this application;

FIG. 1B illustrates a schematic diagram of another network architecture according to an embodiment of this application;

FIG. 1C illustrates a schematic diagram of another network architecture according to an embodiment of this application;

FIG. 1D illustrates a schematic diagram of another network architecture according to an embodiment of this application;

FIG. 2 illustrates a schematic flowchart of an information sending method according to an embodiment of this application;

FIG. 3 illustrates a schematic flowchart of an information receiving method according to an embodiment of this application;

FIG. 4 illustrates a schematic flowchart of reporting characteristic information of a non-Wi-Fi signal according to an embodiment of this application;

FIG. 5 illustrates another schematic flowchart of reporting characteristic information of a non-Wi-Fi signal according to an embodiment of this application;

FIG. 6 illustrates another schematic flowchart of reporting characteristic information of a non-Wi-Fi signal according to an embodiment of this application;

FIG. 7 illustrates a schematic diagram of a field format of characteristic information of a non-Wi-Fi signal according to an embodiment of this application;

FIG. 8 illustrates a schematic diagram of a field format for indicating the collection of characteristic information of a non-Wi-Fi signal according to an embodiment of this application; and

FIG. 9 illustrates a schematic structural diagram of an electronic device according to an embodiment of this application.

### DETAILED DESCRIPTION OF EMBODIMENTS

To facilitate a better understanding of technical solutions of this application by those skilled in the art, methods, devices, and storage media for information sending, and information receiving provided by this application are described in detail with reference to the accompanying drawings.

Exemplary embodiments are described below more fully with reference to the accompanying drawings, but the described exemplary embodiments may be embodied in various forms and should not be construed as being limited to the embodiments set forth herein. On the contrary, a purpose of providing these embodiments is to make this application thorough and complete and to enable those skilled in the art to fully understand the scope of this application.

As used herein, the term “and/or” includes any and all combinations of one or more of associated listed items.

The terms used herein are merely for describing specific embodiments and are not intended to limit this application. As used herein, the singular forms “a” and “the” are also intended to include the plural forms, unless the context clearly indicates otherwise. It should also be understood that when the terms “include” and/or “be made of” are used in this specification, the presence of characteristics, entities, steps, operations, elements, and/or components is specified, but the presence or addition of one or more of other characteristics, entities, steps, operations, elements, components, and/or groups thereof is not excluded.

In the following description, the term “some embodiments” is involved and describes subsets of all possible embodiments, but it may be understood that “some embodiments” may be the same subset or different subsets of all the possible embodiments, and may be combined with one another without conflict.

Unless additionally defined, all terms (including technological and scientific terms) used herein have the same meaning usually understood by those of ordinary skill in the art. It should also be understood that the terms such as those defined in commonly used dictionaries are to be interpreted as having meanings that are consistent with the meanings in the context of the related art and this application, and are not to be interpreted as having idealized or extremely formalized meanings, unless explicitly so defined in the embodiments of this application.

At present, various countries or regions have set corresponding electromagnetic wave frequency bands for industrial, scientific, and medical fields, which are called industrial scientific medical (ISM) bands. The ISM band is an unlicensed or license-exempt frequency band, meaning no need to apply for a license from a dedicated authority to utilize it.

In view of the license-exempt use of the ISM band, products employing other non-Wi-Fi communication technologies also use the same ISM band. Products such as a Bluetooth device, a ZigBee device, a wireless telephone, and a microwave oven, all utilize the ISM band. Therefore, when the Wi-Fi technology is first applied, there is a possibility of conflict with spectrum resources of other wireless products.

The rapid growth in types and quantities of Wi-Fi products is largely attributed to the license-exempt frequency band as a key factor. However, after the large-scale popularization of Wi-Fi, the use of wireless resources in the license-exempt frequency band by devices causes more and more conflicts, and the signal interference between the devices in turn has become the constraint of the application of Wi-Fi technology in scenarios. Therefore, how to reduce the signal interference when the device uses Wi-Fi communication has become an urgent technical problem to be solved in the field.

Based on this, embodiments of this application provide methods, devices, and storage media for information sending, and information receiving, which can reduce signal interference when the device uses Wi-Fi communication.

The information sending method and the information receiving method provided by this application may be applied to a wireless communication system. The wireless communication network may include a wireless local area network (WLAN), a cellular mobile communication network, or the like. The method may be implemented by a communication device in the wireless communication system or a logic circuit or a processor in the communication device. The wireless communication system includes an access point (AP) device and a station (STA) device. The station device is also called a non-access point (non-AP) device, where the access point device acts as a repeater in a wireless network and is a device for connecting a wireless terminal device to a local area network (LAN) or the Internet. Exemplarily, the access point device may include various forms of macro base stations, micro base stations, relay stations, etc., or the access point device may be a switch, a bridge, etc. The station device is a client device of the wireless communication system, which is a device for connecting to the wireless network and the access point device, communicating with other station devices, and accessing network resources, and the station device may be a handheld device, an in-vehicle device, a wearable device, or a computing device with a wireless communication function. Exemplarily, the station device may be a mobile phone, a tablet, or a computer with a wireless receiving and sending function, or may also be a virtual reality (VR) terminal device, an augmented reality (AR) terminal device, a wireless terminal in industrial control, a wireless terminal in autonomous driving, a wireless terminal in remote medical, a wireless terminal in a smart grid, a wireless terminal in a smart city, a wireless terminal in a smart home, etc.

The access point device and the station device may be multi-link devices (MLDs). The multi-link device refers to a wireless communication device capable of communicating on different channels of the same frequency band at the same time, or capable of communicating on different frequency bands at the same time. If the access point device is the multi-link device, namely, a multi-link access point device (multi-link device AP, AP MLD), the device includes one or more access points. If the station device is the multi-link device, namely, a multi-link station device (multi-link device non-AP, non-AP MLD), the device includes one or more access points.

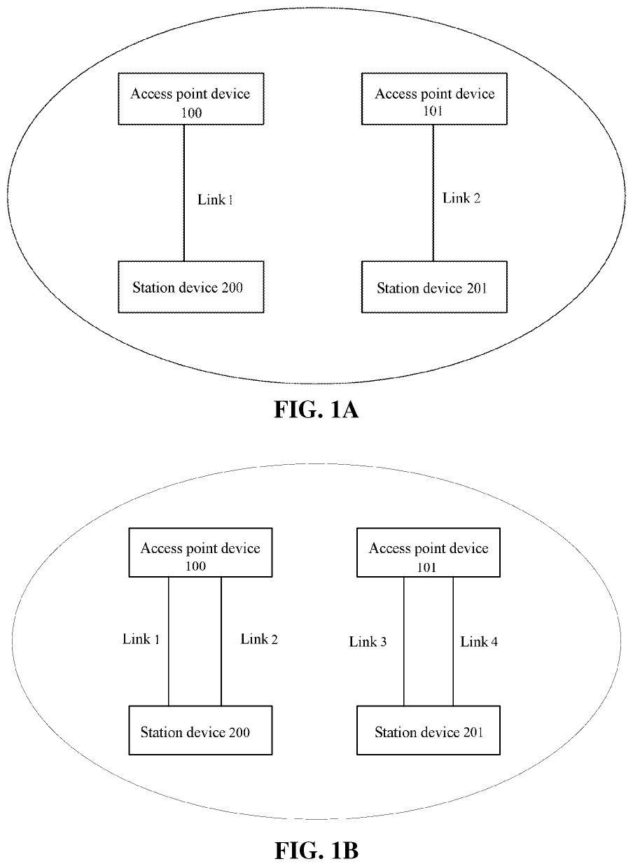

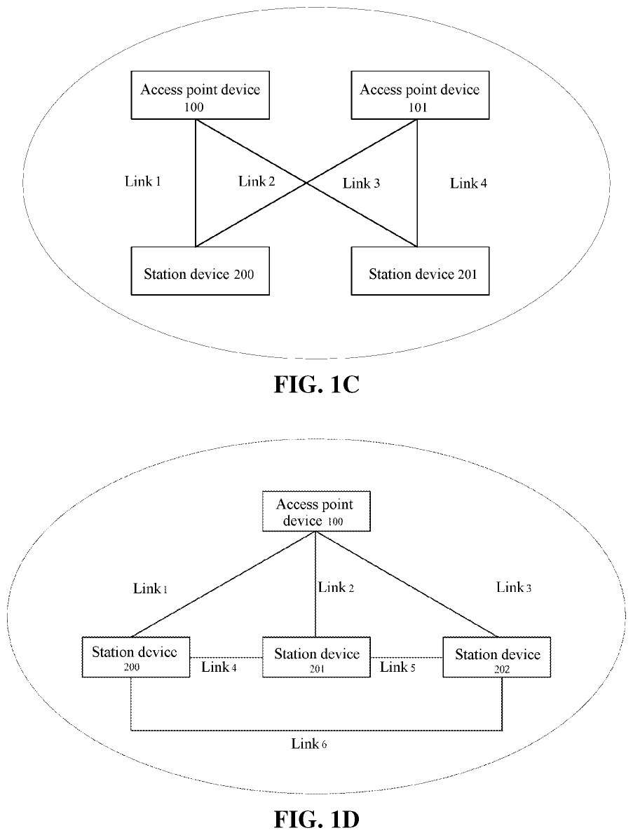

Please refer to FIG. 1A, which illustrates a schematic diagram of a network architecture according to an embodiment of this application. As shown in FIG. 1A, the network architecture according to this embodiment of this application includes an access point device 100, an access point device 101, a station device 200, and a station device 201, where the station devices establish a communication connection with the access point devices through related links to access network resources. Specifically, the station device 200 establishes a communication connection with the access point device 100 through a link 1, and the station device 201 establishes a communication connection with the access point device 202 through a link 2.

Please refer to FIG. 1B, which illustrates a schematic diagram of another network architecture according to an embodiment of this application. As shown in FIG. 1B, the network architecture includes an access point device 100, an access point device 101, a station device 200, and a station device 201, where the access point devices and the station devices are multi-link devices, and the station devices establish a communication connection with the access point devices through related links to access network resources. Specifically, the station device 200 establishes a communication connection with the access point device 100 through a link 1 and a link 2, respectively, and the station device 201 establishes a communication connection with the access point device 101 through a link 3 and a link 4, respectively.

Please refer to FIG. 1C, which illustrates a schematic diagram of another network architecture according to an embodiment of this application. As shown in FIG. 1C, the network architecture includes an access point device 100, an access point device 101, a station device 200, and a station device 201, where the station devices establish communication connections with a plurality of access point devices through related links to access network resources. Specifically, the station device 200 establishes communication connections with the access point device 100 and the access point device 101 through a link 1 and a link 2, respectively, and the station device 201 establishes communication connections with the access point device 100 and the access point device 101 through a link 3 and a link 4, respectively.

Please refer to FIG. 1D, which illustrates a schematic diagram of another network architecture according to an embodiment of this application. As shown in FIG. 1D, the network architecture according to this embodiment of this application includes an access point device 100, a station device 200, a station device 201, and a station device 202, where the station devices establish communication connections with the access point device through related links to access network resources. Specifically, the station device 200 establishes a communication connection with the access point device 100 through a link 1, the station device 201 establishes a communication connection with the access point device 100 through a link 2, and the station device 202 establishes a communication connection with the access point device 100 through a link 3. Additionally, the station device 200 and the station device 201, the station device 201 and the station device 202, as well as the station device 200 and the station device 202, establish communication connections with each other through a link 4, a link 5, and a link 6 respectively, enabling direct data transmission with each other.

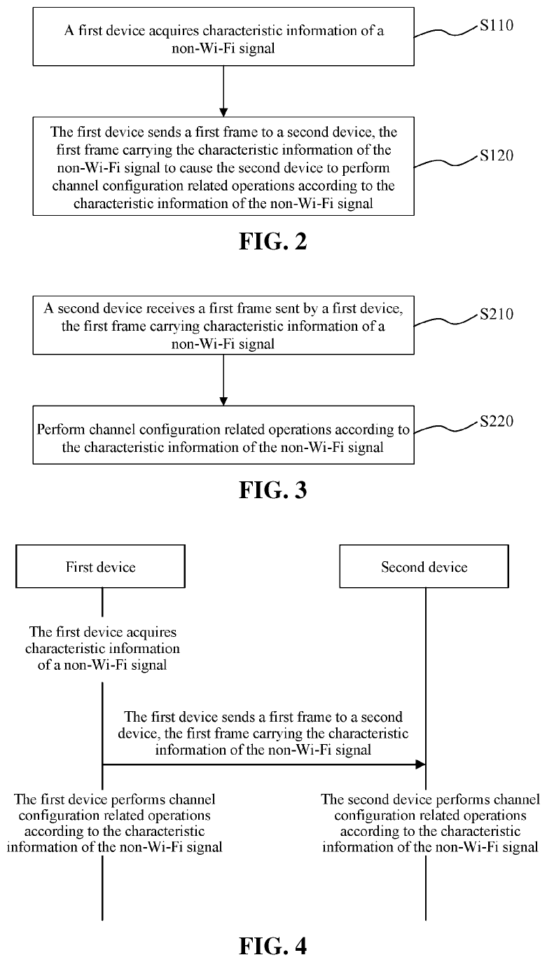

An embodiment of this application first provides an information sending method. Please refer to FIG. 2, which shows an information sending method according to an embodiment of this application. As shown in FIG. 2, the method includes, but is not limited to, step S110 and step S120.
Step S110: A first device acquires characteristic information of a non-Wi-Fi signal.

It should be understood that the non-Wi-Fi signal refers to a wireless communication signal other than a Wi-Fi signal, which specifically may be a wireless communication signal using the same frequency band as the Wi-Fi signal, such as a Bluetooth signal, a direct sequence spread spectrum (DSSS) signal, and an analog signal. The characteristic information of the non-Wi-Fi signal refers to various signal characteristics of the non-Wi-Fi signal, which specifically may be characteristic information for describing performance, coverage, or connection quality of the Wi-Fi signal, such as a duration, a signal strength, and an operating channel.
Step S120: The first device sends a first frame to a second device, the first frame carrying the characteristic information of the non-Wi-Fi signal to cause the second device to perform channel configuration related operations according to the characteristic information of the non-Wi-Fi signal.

It should be understood that the first device sends the first frame carrying the characteristic information of the non-Wi-Fi signal to the second device, so that the second device can perform the channel configuration related operations according to the characteristic information of the non-Wi-Fi signal. For example, the second device selects an operating channel with reference to the characteristic information of the non-Wi-Fi signal, thereby avoiding the operating channel of the non-Wi-Fi signal or a surrounding channel affected by the non-Wi-Fi signal.

In this embodiment of this application, the first device acquires the characteristic information of the non-Wi-Fi signal, then the first device sends the first frame carrying the characteristic information of the non-Wi-Fi signal to the second device, the second device receives the first frame carrying the characteristic information of the non-Wi-Fi signal sent by the first device, and then the second device performs the channel configuration related operations according to the characteristic information of the non-Wi-Fi signal, which can reduce signal interference when the devices use Wi-Fi communication, reduce a data transmission delay of the devices, improve the stability of data transmission, and increase a channel utilization rate.

In some embodiments, the characteristic information of the non-Wi-Fi signal includes at least one of the following: time domain characteristic information, frequency domain characteristic information, or non-Wi-Fi signal type information, where the time domain characteristic information includes at least one of the following: signal period characteristic information or signal duration information.

The frequency domain characteristic information includes at least one of the following: signal transmit power information, received signal strength information, signal operating class information, signal operating channel number information, number information about surrounding channels affected by a signal, or signal bandwidth information.

The non-Wi-Fi signal type information includes at least one of the following: signal type information or signal name information.

It should be understood that the characteristic information of the non-Wi-Fi signal may include the time domain characteristic information of the signal. From the time domain aspect, the non-Wi-Fi signal may be divided into a periodic signal and an aperiodic signal. The periodic signal refers to a signal with a fixed access time and period. For example, the Bluetooth signal is a periodic signal with an access period that may be 3.75 ms or 7.5 ms. The aperiodic signal refers to a signal with an access time or period not fixed. For example, a microwave signal generated by a microwave oven device is an aperiodic signal. When the microwave oven device works, the generated microwave signal continuously occupies the signal until the microwave oven device stops working. Therefore, time domain characteristics of the signal may be described by the signal period characteristic information or the signal duration information, so that the second device can perform the channel configuration related operations using the time domain characteristic information of the signal, and can perform related operations such as channel avoidance from a temporal perspective to reduce signal interference of the non-Wi-Fi signal to the device using the Wi-Fi communication technology.

It should be understood that the characteristic information of the non-Wi-Fi signal may also include the frequency domain characteristic information of the signal. Specifically, the frequency domain characteristic information may include the following content: signal transmit power information, received signal strength information, signal operating class information, signal operating channel number information, surrounding channel number information affected by the signal, or signal bandwidth information.

It should be noted that the signal transmit power information is an indicator used to measure the power used by the wireless communication device when transmitting a radio frequency signal, typically expressed in decibels-milliwatt (dBm). For example, when the first device serves as a sender of the non-Wi-Fi signal, the first device may report the transmit power information of the non-Wi-Fi signal to the second device. The received signal strength information is an indicator used to measure the strength of the received radio frequency signal, also typically expressed in decibels-milliwatt (dBm). For example, the first device obtains the non-Wi-Fi signal through spectrum scanning, that is, the first device may serve as a receiver of the non-Wi-Fi signal, calculate the received signal strength information of the non-Wi-Fi signal, and report the received signal strength information to the second device.

On one hand, in terms of signal strength, the non-Wi-Fi signal is divided into a strong signal and a weak signal. Taking a threshold value of the Wi-Fi signal as an example (−82 dBm, −62 dBm), when the signal strength of an interference signal is less than the lowest threshold value, that is, less than −82 dBm, a Wi-Fi device is less disturbed by the signal. When the signal strength of the interference signal is within the threshold value, the Wi-Fi device may still access a channel. However, when the signal strength of interference signal is greater than the highest threshold value, that is, greater than −62 dBm, the Wi-Fi device suffers serious signal interference and can hardly access the channel. Therefore, signal strength characteristics of the signal may be described through the signal transmit power information or received signal strength information, enabling the second device to utilize the signal strength characteristics of the signal for performing the channel configuration related operations and to perform channel avoidance and other related operations in terms of signal strength, thereby reducing signal interference from the non-Wi-Fi signal on the device using the Wi-Fi communication technology.

It should be noted that the operating class information refers to a frequency band or frequency range in which the signal operates, such as a 2.4 GHz frequency band, a 5 GHz frequency band, or a 6 GHz frequency band. An operating channel number refers to a channel number within a corresponding frequency band in which the signal operates. For example, the 2.4 GHz frequency band is typically divided into 14 channels, and the 14 channels correspond to channel numbers ranging from 1 to 14. In other words, if the operating channel type of the signal is the 2.4 GHz frequency band, the operating channel number is at least one of the channel numbers from 1 to 14.In addition, an operating frequency range of the 2.4 GHz frequency band is from 2.402 GHz to 2.483 GHz, where each channel has a bandwidth of 22 MHz, and center frequency points of each channel increase in multiples of 5 MHz, with an effective bandwidth of 20 MHz and the remaining 2MHz belonging to an isolation guard bandwidth. Within the entire 2.4 GHz frequency band, only channels 1, 6, and 11 do not overlap with each other. That is, channels in the frequency band of 2.4 GHz, except for the channels 1, 6, and 11, may interfere with adjacent channels. Therefore, number information about surrounding channels affected by a signal may be used for description. For example, if the non-Wi-Fi signal operates on the channel 8 in the frequency band of 2.4 GHz, the number information about surrounding signal channels affected by the signal is about the channels 7 and 9. The signal bandwidth information refers to a frequency spectrum range occupied by the signal, typically expressed in Hertz (Hz). For example, a channel bandwidth of the Bluetooth signal is 1 MHz, while 4G LTE utilizes a bandwidth of 5 MHz, 10 MHz, or 20 MHz.

On the other hand, in terms of the frequency domain, the non-Wi-Fi signal may be divided into a broadband signal and a narrowband signal. The broadband signal refers to a signal operating on a wide range of frequency bands, for example, signals generated by a Bluetooth device and the microwave oven device operate in the entire frequency band of 2.4 GHz. The narrowband signal refers to a signal operating on a narrow range of frequency bands. For example, a signal generated by an analog cordless phone only operates on channels 1, 2 and 3 of a corresponding frequency band, and for another example, a signal generated by a direct sequence spread spectrum (DSSS) phone only operates on a channel 165 of a corresponding frequency band. Therefore, frequency domain characteristics of the signal may be described through the signal operating class information, the signal operating channel number information, the number information about the surrounding channels affected by the signal, or the signal bandwidth information, thereby allowing the second device to perform the channel configuration related operations by using the frequency domain characteristic information of the signal and to perform channel avoidance and related operations from the frequency domain perspective to reduce signal interference of the non-Wi-Fi signal to the device using the Wi-Fi communication technology.

It should be understood that the non-Wi-Fi signal type information may also include non-Wi-Fi signal type information. Specifically, the non-Wi-Fi signal type information includes signal type information or signal name information. The signal type information is a type of the non-Wi-Fi signal, such as a Bluetooth signal, a direct sequence spread spectrum signal, or an analog signal, and the signal name information is a specific name of the non-Wi-Fi signal.

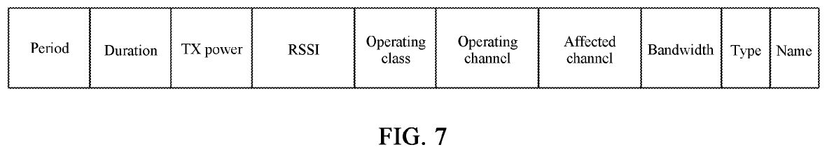

In a specific embodiment, please refer to FIG. 7, which illustrates a schematic diagram of a field format of characteristic information of a non-Wi-Fi signal according to an embodiment of this application. As shown in FIG. 7, a first frame sent by a first device to a second device includes fields: a period, a duration, transmit power (TX power), a received signal strength indicator (RSSI), an operating class, an operating channel, an affected channel, a bandwidth, a type, and a name, which are respectively used to carry signal period characteristic information, signal duration information, transmit power information, signal strength information, operating class information, operating channel number information, numbers of surrounding channels affected by the signal, bandwidth information, signal type information, and signal name information of the non-Wi-Fi signal. The first device carries the characteristic information of the non-Wi-Fi signal in the fields shown in FIG. 7 within the first frame and sends the first frame to the second device, thereby allowing the second device to analyze the non-Wi-Fi signal based on characteristic information from three dimensions including the time domain, the frequency domain, and the signal strength, and further determine a method for channel access. Accordingly, the interference of the non-Wi-Fi signal to the Wi-Fi signal transmission by the device is reduced, the data transmission delay of the device can be reduced, and the data transmission stability and channel utilization rate of the device are improved.

It should also be noted that the above-mentioned embodiment describes the information specifically included in the characteristic information of the non-Wi-Fi signal, namely the signal period characteristic information, the signal duration information, the signal transmit power information, the received signal strength information, the signal operating class information, the signal operating channel number information, the number information about the surrounding channels affected by the signal, the signal bandwidth information, the signal type information, or the signal name information. In practical application, the first device may carry one or more pieces of the above-mentioned characteristic information by using corresponding fields in a transmission frame according to other negotiated regulations, or other characteristic information other than the above-mentioned example. This embodiment of this application does not impose limitations in this regard.

In some embodiments, the first frame is one of the following: a beacon frame, a probe response frame, a multi-link probe response frame, an association request frame, a reassociation request frame, an association response frame, a reassociation response frame, an authentication frame, or an action frame.

It should be understood that a Wi-Fi communication technology is based on an IEEE 802.11 standard protocol series. In the 802.11 standard protocol series, all transmission frames are classified into data frames, control frames, and management frames, where the management frames are primarily responsible for supervising and managing the joining or leaving of a wireless network and maintaining communication between access points and stations.

The following describes types of frames included in the management frames, where an AP may be an access point (AP), a multi-link access point (AP MLD), or an affiliated access point (affiliated AP) of the AP MLD, and an STA may be a station (STA), a multi-link station (non-AP MLD), or an affiliated station of the non-AP MLD:

Regarding the beacon frame, the beacon frame is sent by the AP providing a service and is configured to announce the existence of a basic service set (BSS). The beacon frame carries basic information of the BSS, such as a basic service set identifier (BSSID), a service set identifier (SSID), a channel, a frequency, a signal strength, and a country code.

Regarding the probe request frame, the probe request frame is sent by the STA to the AP to probe for surrounding BSSs. If the request frame specifies the SSID, the AP in the BSS that is consistent with the requested SSID responds through the probe response frame. If the request frame does not specify the SSID, APs in all the BSSs respond.

Regarding the probe response frame, the AP responds, by the probe response frame, to the probe request frame sent by the STA.

Regarding the multi-link probe request frame, the probe request frame is sent by the STA to the AP to probe for surrounding AP MLDs.

Regarding the multi-link probe response frame, the AP MLD responds, by the multi-link probe response frame, the multi-link probe request frame sent by the STA.

Regarding the association request frame, after the STA finds the AP and passes authentication, the STA sends the association request frame to the AP to request the AP for association. The association request frame carries basic information about the STA.

Regarding the association response frame, the AP responds, by the association response frame, to the association request frame sent by the STA.

Regarding the reassociation request frame, when the STA moves away from an original AP and discovers a new AP with a stronger signal within the same ESS, the STA sends the reassociation request frame to the new AP.

Regarding the reassociation response frame, the AP responds, by the reassociation response frame, to the reassociation request frame sent by the STA.

Regarding a disassociation frame, the disassociation frame is sent by the STA to the AP to terminate an association relationship with the AP.

Regarding the authentication frame, the STA sends the authentication frame to the AP, and the AP performs authentication according to an inputted password and sends an authentication result back to the STA.

Regarding a de-authentication frame, the de-authentication frame is configured to terminate an authentication relationship. Specifically, the STA sends the de-authentication frame to the AP to actively forget the SSID, or the AP sends the de-authentication frame to the STA to actively propose terminating the connection with the STA.

Regarding the action frame, the STA sends the action frame to the AP to request the AP to perform specific operations.

Therefore, when the first device is an AP device, the first device may carry the characteristic information of the non-Wi-Fi signal with idle fields in the beacon frame, the probe response frame, the multi-link probe response frame, the association response frame, the reassociation response frame, or the de-authentication frame, and when the first device is an STA device, the first device may carry the characteristic information of the non-Wi-Fi signal with idle fields in the authentication frame, the probe request frame, the multi-link probe request frame, the reassociation request frame, the de-association frame, the de-authentication frame, or the action frame.

It should be noted that the above-mentioned embodiment describes a protocol format of the first frame sent by the first device, that is, the first frame may be a management frame in the 802.11 standard protocol, such as the beacon frame, the probe request frame, the probe response frame, the multi-link probe request frame, the multi-link probe response frame, the association request frame, the association response frame, the reassociation request frame, the reassociation response frame, the de-association frame, the authentication frame, the de-authentication frame, or the action frame. In practical applications, the first device may also use a data frame or a control frame defined in the 802.11 standard protocol, or use a frame defined by other standard protocols to carry the characteristic information of the non-Wi-Fi signal. This embodiment of this application does not impose limitations in this regard.

In some embodiments, the message sending method further includes at least one of the following steps:
the first device sends a second frame to the second device, the second frame carrying non-Wi-Fi signal characteristic capability information of the first device; or
the first device receives a third frame sent by the second device, the third frame carrying non-Wi-Fi signal characteristic capability information of the second device.

It should be understood that the first device may select to send the second frame carrying its own non-Wi-Fi signal characteristic capability information to the second device to inform the second device of a non-Wi-Fi signal characteristic capability of the first device, and the second device may also select to send the third frame carrying its own non-Wi-Fi signal characteristic capability information to the first device to inform the first device of a non-Wi-Fi signal characteristic capability of the second device. That is, in the wireless communication system, each wireless communication device may send its own non-Wi-Fi signal characteristic capability information to other devices. For example, the wireless communication device has a Bluetooth signal transmitting capability, and the specific capability information comprises time domain characteristic information, frequency domain characteristic information, and signal strength information of a transmitted Bluetooth signal. The wireless communication device informs other devices of its own non-Wi-Fi signal characteristic capability, so that the other devices can determine a method for channel access according to the non-Wi-Fi signal characteristic capability of the current wireless communication device when performing Wi-Fi communication with the current wireless communication device, so as to reduce the interference of the non-Wi-Fi signal and improve the stability of communication.

In some embodiments, the second frame and/or the third frame may be one of the following: a beacon frame, a probe response frame, a multi-link probe response frame, an association request frame, a reassociation request frame, an association response frame, a reassociation response frame, an authentication frame, or an action frame.

It should be noted that the above-mentioned embodiment describes that the second frame and/or the third frame may be at least one of the following: the beacon frame, the probe response frame, the multi-link probe response frame, the association request frame, the reassociation request frame, the association response frame, the reassociation response frame, the authentication frame, or the action frame. For specific descriptions, reference may be made to the detailed descriptions of the first frame. Details are not repeated in this embodiment of this application.

In some embodiments, the second frame and/or the third frame include a first field, and the non-Wi-Fi signal characteristic capability information is located in the first field. The first field is one of the following: a neighbor report (NR) field, a reduced neighbor report (RNR) field, or a multiple basic service set identifier (MBSSID) field.

It should be understood that the NR field is configured to carry information about other surrounding access points (APs), the station (STA) sends a query frame to a target access point (AP) to query the information of the other surrounding access points (APs), and the target access point (AP) sends a response frame containing the NR field to the station (STA) to feed back information about other queried surrounding access points (APs) to the station (STA). For example, the STA sends an access network query protocol (ANQP) query frame to the AP, and the AP feeds back an ANQP response frame to the STA. Alternatively, the AP actively broadcasts information about other surrounding APs using the NR field in the beacon frame and the probe response frame. Alternatively, in a roaming or multi-AP load balancing scenario, the AP actively recommends information about other surrounding APs to the STA, and the STA sends an (re) association request to the recommended AP after confirming the information. For example, the AP sends a BSS transition management request (BTM request) frame to the STA and carries information about the recommended AP in an NR field of the BTM request frame, and then the STA sends a BTM response frame including an NR field carrying information about the desired AP to be connected, and sends an authentication frame and an (re) association frame to a target AP to establish a connection with the target AP. The first device or the second device may utilize the NR field to carry its own non-Wi-Fi signal characteristic capability information.

In order to reduce the channel resource overhead caused by a field length, on the basis of the NR field, the reduced neighbor report (RNR) field is clipped and modified accordingly, and only includes key information about surrounding APs, such as an operating channel, an SSID, and a BSSID. The first device or the second device may utilize the RNR field to carry its non-Wi-Fi signal characteristic capability information.

The multiple BSSID (MBSSID) field allows a plurality of APs to be created on a single Wi-Fi radio frequency link, with each AP corresponding to a different BSSID. To reduce the channel resource overhead for each AP when sending the management frames such as the beacon frame and the probe response frame, the 802.11 standard protocol introduces an MBSSID technology. That is, the beacon frames and the probe response frames sent by the plurality of APs on the same radio frequency are merged into the beacon frame and the probe response frame of a single AP. In other words, the beacon frame and the probe response frame of the single AP carry information about other APs on the same radio frequency, and the information is placed in a multiple BSSID element field, with a field format including an element identifier (element ID), an element length, a maximum BSSID number indicator (MaxBSSID Indicator), and optional subelements. Detailed information about the other APs is stored in an optional subelements field. The first device or the second device may utilize the MBSSID field to carry non-Wi-Fi signal characteristic capability information of the other APs on the same radio frequency.

In a specific embodiment, if the second device is an access point device, the beacon frame, the probe response frame, or the multi-link probe response frame sent by the second device carries characteristic information of a non-Wi-Fi signal of a neighbor access point (AP), and the characteristic information of the non-Wi-Fi signal is carried in the NR field, the RNR field, or the MBSSID field.

In some embodiments, before the first device sends the first frame to the second device, the method further includes:
receiving, by the first device, a fourth frame sent by the second device, where the fourth frame is configured to instruct the first device to collect the characteristic information of the non-Wi-Fi signal.

The fourth frame carries at least one of the following information: a receiving terminal media access control (MAC) address, collection duration information, delay boundary information, collection mode information, received signal strength information, operating class information, channel number information, type information, or name information.

It should be understood that the second device sends the fourth frame to the first device, where the fourth frame carries at least one of the receiving terminal MAC address, the collection duration information, the delay boundary information, the collection mode information, the received signal strength information, the operating class information, the channel number information, the type information, or the name information, and through the specific information carried by the fourth frame, the first device is instructed to collect relevant characteristic information of the non-Wi-Fi signal.

Specifically, the second device instructs the first device corresponding to the MAC address to collect the characteristic information of the non-Wi-Fi signal. The collection duration information is configured to indicate a specific time at which the first device performs signal collection. The delay boundary information refers to a maximum allowed collection delay. A collection mode is configured to indicate whether the first device performs a frequency band scan based on a local frequency band history scan record or performs a frequency band scan in real time. A received signal strength is configured to indicate a received signal strength threshold value for the non-Wi-Fi signal collected by the first device. The operating class information is configured to indicate that the first device scans a specific channel or scans a full frequency band. The type information is configured to instruct the first device to scan a specific signal type, such as a Bluetooth signal, an analog signal, or a DSSS signal. The name information is configured to instruct the first device to scan a specific signal name.

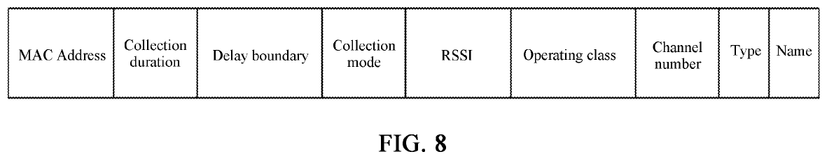

In a specific embodiment, please refer to FIG. 8, which illustrates a schematic diagram of a field format for indicating the collection of characteristic information of a non-Wi-Fi signal according to an embodiment of this application. As shown in FIG. 8, the fourth frame sent by the second device to the first device contains fields: an MAC address, a collection duration, a delay boundary, a collection mode, a received signal strength (RSSI), an operating class (regulatory), a channel number, a type, and a name, which are configured to carry the receiving terminal MAC address, the collection duration information, the delay boundary information, the collection mode information, the received signal strength information, the operating class information, the channel number information, the type information, or the name information, respectively. The second device carries instruction information for instructing the first device to collect the characteristic information of the non-Wi-Fi signal through the fields shown in FIG. 8 in the fourth frame and sends the fourth frame to the first device, thereby allowing the first device to collect the characteristic information of the non-Wi-Fi signal according to the instruction information carried in the fourth frame.

It should also be noted that the above-mentioned embodiment describe the instruction information specifically included in the fourth frame, namely, the receiving terminal MAC address, the collection duration information, the delay boundary information, the collection mode information, the received signal strength information, the operating class information, the channel number information, the type information, and the name information. In practical applications, the second device may carry one or more pieces of the above-mentioned instruction information or other instruction information other than the above-mentioned examples using corresponding fields in the transmission frame according to actual needs. This embodiment of this application does not impose limitations in this regard.

In some embodiments, the first device acquiring characteristic information of a non-Wi-Fi signal including at least one of the following:
acquiring characteristic information of a locally configured non-Wi-Fi signal; or
acquiring characteristic information of a non-Wi-Fi signal received from a third device.

It should be understood that a method in which the first device acquires the characteristic information of the non-Wi-Fi signal includes: the first device acquires the characteristic information of the locally configured non-Wi-Fi signal, that is, the first device collects the characteristic information of the non-Wi-Fi signal, and sends the collected characteristic information of the non-Wi-Fi signal to the second device to inform the second device that the non-Wi-Fi signal and the characteristic information thereof exist near the first device. Relatively, the method in which the first device acquires the characteristic information of the non-Wi-Fi signal may further include: the first device acquires the characteristic information of the non-Wi-Fi signal received from the third device, that is, the third device sends the collected characteristic information of the non-Wi-Fi signal to the first device, and the first device forwards the characteristic information of the non-Wi-Fi signal received from the third device to the second device, achieving sharing of the characteristic information of the non-Wi-Fi signal among a plurality of wireless communication devices, so that the device can perform the channel configuration related operations according to the characteristic information of the non-Wi-Fi signal collected by the device and other devices, thereby reducing interference of the non-Wi-Fi signal to a Wi-Fi signal.

In some embodiments, the third device is an access point (AP) device or a station (STA) device.

It should be understood that the third device may be the access point device, that is, the third device as the access point device sends the characteristic information of the non-Wi-Fi signal to the first device, and correspondingly, according to a device type (the access point device or the station device) of the first device, the third device may utilize the beacon frame, the probe response frame, the multi-link probe response frame, the association response frame, or the reassociation response frame, and carry the characteristic information of the non-Wi-Fi signal through the NR field, the RNR field, or the MBSSID field. In addition to the transmission frames and fields listed above, the third device as the access point device may also send the characteristic information of the non-Wi-Fi signal to the first device by other methods, and this embodiment of this application does not impose limitations in this regard.

The third device may also be the station device, that is, the third device as the station device sends the characteristic information of the non-Wi-Fi signal to the first device, and correspondingly, according to the device type (the access point device or the station device) of the third device, the third device may utilize the probe request frame, the multi-link probe request frame, the association request frame, the reassociation request frame, the authentication frame, or the action frame, and carry the characteristic information of the non-Wi-Fi signal by selecting the NR field, the RNR field, or the MBSSID field. In addition to the transmission frames and fields listed above, the third device as the station device may also send the characteristic information of the non-Wi-Fi signal to the first device by other methods, and this embodiment of this application does not impose limitations in this regard.

In some embodiments, the characteristic information of the locally configured non-Wi-Fi signal is acquired according to at least one of the following:
acquiring the characteristic information of the non-Wi-Fi signal through spectrum scanning; or
acquiring the characteristic information of the non-Wi-Fi signal through a local non-Wi-Fi service.

It should be understood that a method for acquiring the characteristic information of the locally configured non-Wi-Fi signal includes: acquiring the characteristic information of the non-Wi-Fi signal through spectrum scanning. That is, the first device performs scanning in a certain frequency band to determine whether the non-Wi-Fi signal exists and determine the characteristic information of the non-Wi-Fi signal. Specifically, the first device may perform a full spectrum scan with a local scanning radio frequency or scan for a specific spectrum. Exemplarily, the Wi-Fi signal may operate in a frequency band of 2.4 Hz, 5 GHz, or 6 GHz, and therefore, the first device may scan for signals that may interfere with the Wi-Fi signal in the frequency band 2.4 GHz, 5 GHz, or 6 GHz. After detecting the non-Wi-Fi signal, the first device locally generates the characteristic information of the non-Wi-Fi signal.

In a specific embodiment, the first device receives the fourth frame sent by the second device, the fourth frame is configured for instructing the first device to collect the characteristic information of the non-Wi-Fi signal, and the first device obtains the characteristic information of the corresponding non-Wi-Fi signal through spectrum scanning according to the instruction information carried in the fourth frame. For example, the fourth frame carries the operating class information and the channel number information, where the operating class information is 2.4 GHz and the channel number information is 9 and 10. That is, the second device instructs the first device to scan the channels 9 and 10 in the frequency band of 2.4 GHz. The first device scans the channels 9 and 10 in the frequency band of 2.4 GHz, and after detecting the non-Wi-Fi signal, the first device locally generates the characteristic information of the non-Wi-Fi signal.

It should be understood that a method for acquiring the characteristic information of the locally configured non-Wi-Fi signal includes: acquiring the characteristic information of the non-Wi-Fi signal according to the local non-Wi-Fi service. The first device has the non-Wi-Fi service, that is, the first device also needs to transmit the non-Wi-Fi signal, and therefore the first device may send the characteristic information of the non-Wi-Fi signal to the second device, so that when the second device communicates with the first device based on the Wi-Fi technology, the corresponding channel configuration related operations can be performed according to the non-Wi-Fi service of the first device, thereby improving the stability of communication.

In some embodiments, after acquiring the characteristic information of the non-Wi-Fi signal, the method further includes:
performing the channel configuration related operations according to the characteristic information of the non-Wi-Fi signal.

The channel configuration related operations include at least one of the following:
a channel switching operation;
an operating channel selecting operation;
a direct-link channel selecting operation;
a dynamic frequency selection channel operation;
a preamble masking channel configuration operation; or
an energy detection threshold value configuration operation.

It should be understood that the channel switching operation means that the first device switches from an original operating channel to a target operating channel with reference to the characteristic information of the non-Wi-Fi signal locally stored or acquired from other devices. For example, the characteristic information of the non-Wi-Fi signal indicates that a non-Wi-Fi signal using the same operating channel as the first device currently exists, such as the channel 8 in the frequency band of 2.4 GHz, the surrounding channels affected by the non-Wi-Fi signal are 7 and 9, and therefore, the first device may select to switch from the channel 8 in the frequency band of 2.4 GHz to other channels except for the channels 7 and 9 to avoid the operating channel of the non-Wi-Fi signal and the surrounding channels affected by the non-Wi-Fi signal. The channel may be an operating channel between the station device and the access point device, a direct-link channel between station devices, or the like.

The operating channel selecting operation means that the first device selects an operating channel to be accessed with reference to the characteristic information of the non-Wi-Fi signal locally stored or acquired from other devices. For example, the characteristic information of the non-Wi-Fi signal indicates that a non-Wi-Fi signal using the channel 1 in the frequency band of 2.4 GHz currently exists, but the non-Wi-Fi signal does not affect other surrounding channels, and therefore, the first device may select another channel other than the channel 1 in the frequency band of 2.4 GHz as the operating channel.

The direct-link channel selecting operation means that when the first device is the station device and the first device is about to establish a point-to-point direct link with another station device, the first device may select a direct-link channel to be accessed with reference to the characteristic information of the non-Wi-Fi signal locally stored or acquired from other devices.

The dynamic frequency selection (DFS) channel operation means that the first device selects a radar channel to be used or switched to with reference to the characteristic information of the non-Wi-Fi signal locally stored or acquired from other devices. For example, the first device instructs the second device to scan a radar signal in the frequency band of 5 GHz, and when the characteristic information of the non-Wi-Fi signal fed back by the second device indicates that the radar signal is not currently detected in the frequency band of 5 GHz, the first device may select a channel in the frequency band of 5 GHz that has been scanned and the radar signal is not detected, as the radar channel to be used or switched to.

The preamble masking channel configuration operation means that when the first device is the access point device, the first device marks, according to characteristic information of the non-Wi-Fi signal, a channel that coincides with or is affected by the non-Wi-Fi signal as a preamble puncturing subchannel to indicate that the subchannel is unavailable.

The energy detection threshold value configuration operation means that when the first device accesses the channel with reference to the characteristic information of the non-Wi-Fi signal, and the characteristic information of the non-Wi-Fi signal indicates that the channel strength of the current non-Wi-Fi signal is higher than a clear channel assessment energy detection (CCA-ED) default threshold value, the first device increases a threshold value of a CCA-ED within a time window when the non-Wi-Fi signal accesses the channel, so that the first device can access the channel more easily, thereby improving the channel utilization efficiency.

In some embodiments, the first device is an access point (AP) device or a station (STA) device; and the second device is an access point (AP) device or a station (STA) device.

It should be understood that the first device is the access point device or the station device, and the second device is the access point device or the station device. That is, both the access point device and the station device may serve as senders of the characteristic information of the non-Wi-Fi signal, and send the acquired characteristic information of the non-Wi-Fi signal to another access point device or station device, so that the plurality of wireless communication devices within the same basic service range can learn the characteristic information of the current non-Wi-Fi signal, thereby further determining a method for channel access according to the characteristic information of the non-Wi-Fi signal, and thus reducing signal interference of the non-Wi-Fi signal to the device using the Wi-Fi communication technology.

It should be understood that the access point device includes the multi-link access point device, and the station device includes the multi-link station device. When the first device is the multi-link access point device, and the second device is the multi-link station device, or the second device is the multi-link access point device, and the first device is the multi-link station device, as shown in FIG. 1B, the station devices may establish connections with the same access point device through a plurality of different links, or, as shown in FIG. 1C, the station devices may establish connections with the plurality of access point devices through a plurality of different links.

In a specific embodiment, please refer to FIG. 4, which illustrates a schematic flowchart of an information sending method according to an embodiment of this application. As shown in FIG. 4, a first device acquires characteristic information of a non-Wi-Fi signal, and then the first device sends a first frame carrying the characteristic information of the non-Wi-Fi signal to a second device, and the first device and the second device perform channel configuration related operations according to the characteristic information of the non-Wi-Fi signal.

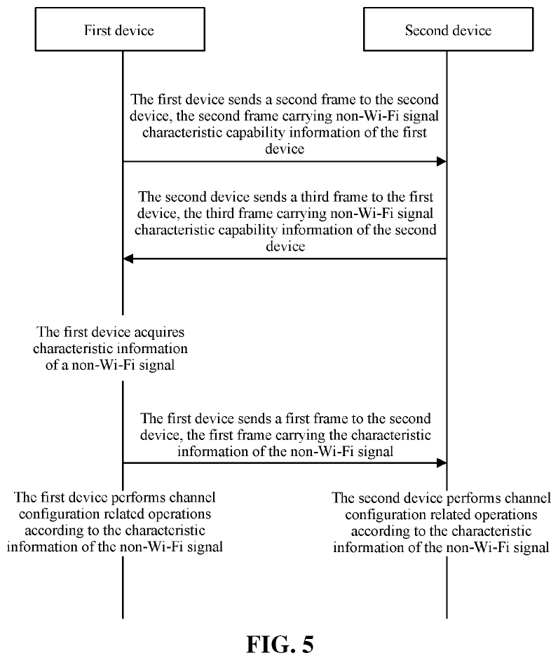

In a specific embodiment, please refer to FIG. 5, which illustrates a schematic flowchart of an information sending method according to an embodiment of this application. As shown in FIG. 5, a first device and a second device exchange their own non-Wi-Fi signal characteristic capability information. Specifically, the first device sends a second frame carrying non-Wi-Fi signal characteristic capability information of the first device to the second device, the second device sends a third frame carrying non-Wi-Fi signal characteristic capability information of the second device to the first device, the first device acquires characteristic information of the non-Wi-Fi signal, then the first device sends a first frame carrying the characteristic information of the non-Wi-Fi signal to the second device, and the first device and the second device perform channel configuration related operations according to the characteristic information of the non-Wi-Fi signal.

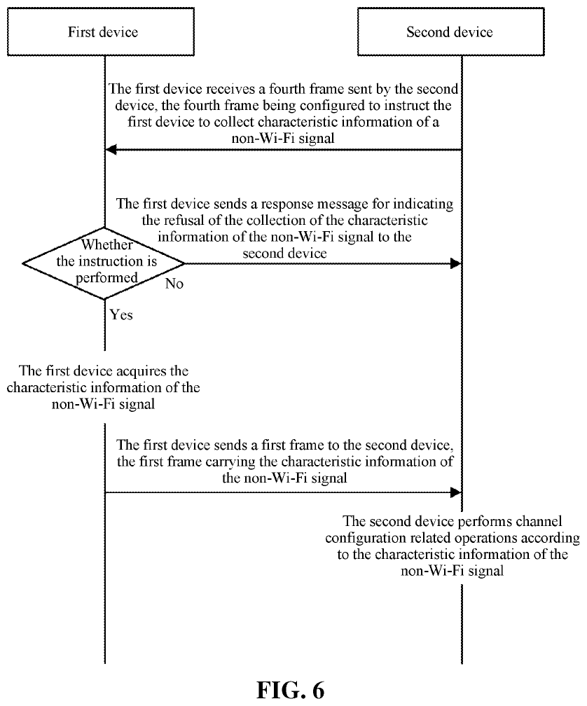

In a specific embodiment, please refer to FIG. 6, which illustrates a schematic flowchart of an information sending method according to an embodiment of this application. As shown in FIG. 6, a second device instructs a first device to collect characteristic information of a non-Wi-Fi signal. Specifically, the second device sends a fourth frame for indicating to collect the characteristic information of the non-Wi-Fi signal to the first device. The first device determines whether to execute the collection indication. If the first device refuses to execute the collection indication, the first device sends a response message for indicating the refusal of the instruction to the second device. If the first device accepts the collection instruction, the first device acquires the characteristic information of the non-Wi-Fi signal and then sends a first frame carrying the characteristic information of the non-Wi-Fi signal to the second device. The second device performs channel configuration-related operations according to the characteristic information of the non-Wi-Fi signal.

An embodiment of this application first provides an information receiving method. Please refer to FIG. 3, which is an information receiving method according to an embodiment of this application. As shown in FIG. 3, the method includes, but is not limited to, step S210 and step S220.
Step S210: A second device receives a first frame sent by a first device, the first frame carrying characteristic information of a non-Wi-Fi signal.
Step S220: Perform channel configuration related operations according to the characteristic information of the non-Wi-Fi signal.

In this embodiment of this application, the second device receives the first frame carrying the characteristic information of the non-Wi-Fi signal sent by the first device and then performs the channel configuration related operations according to the characteristic information of the non-Wi-Fi signal, thereby allowing the second device to avoid an operating channel of the non-Wi-Fi signal or channels affected by the non-Wi-Fi signal, reducing signal interference between devices using the Wi-Fi communication technology, reducing a data transmission delay of the devices, improving the stability of data transmission, and increasing a channel utilization rate.

In some embodiments, the characteristic information of the non-Wi-Fi signal includes at least one of the following: time domain characteristic information, frequency domain characteristic information, or non-Wi-Fi signal type information.

The time domain characteristic information includes at least one of the following: signal period characteristic information or signal duration information.

The frequency domain characteristic information includes at least one of the following: signal transmit power information, received signal strength information, signal operating class information, signal operating channel number information, number information about surrounding channels affected by a signal, or signal bandwidth information.

The non-Wi-Fi signal type information includes at least one of the following: signal type information or signal name information.

It should be noted that the above-mentioned embodiment proposes that the characteristic information of the non-Wi-Fi signal includes at least one of the time domain characteristic information, the frequency domain characteristic information, or the non-Wi-Fi signal type information, and describes specific information that the time domain characteristic information, the frequency domain characteristic information, and the non-Wi-Fi signal type information may include. For detailed descriptions, reference may be made to the description in the information sending method provided in this embodiment of this application, and details are not provided herein.

In some embodiments, the first frame is one of the following: a beacon frame, a probe response frame, a multi-link probe response frame, an association request frame, a reassociation request frame, an association response frame, a reassociation response frame, an authentication frame, or an action frame.

It should be noted that the above-mentioned embodiment proposes that the first frame may be one of the beacon frame, the probe response frame, the multi-link probe response frame, the association request frame, the reassociation request frame, the association response frame, the reassociation response frame, the authentication frame, or the action frame. For detailed descriptions, reference may be made to the description in the information sending method provided in this embodiment of this application, and details are not provided herein.

In some embodiments, the method further includes at least one of the following steps:

The second device receives a second frame sent by the first device, the second frame carrying non-Wi-Fi signal characteristic capability information of the first device; or, the second device sends a third frame to the first device, the third frame carrying non-Wi-Fi signal characteristic capability information of the second device.

It should be noted that the above-mentioned embodiment proposes that the first device and the second device may exchange their own non-Wi-Fi signal characteristic capability information. For detailed descriptions, reference may be made to the description in the information sending method provided in this embodiment of this application, and details are not provided herein.

In some embodiments, the second frame or the third frame is one of the following: a beacon frame, a probe response frame, a multi-link probe response frame, an association request frame, a reassociation request frame, an association response frame, a reassociation response frame, an authentication frame, or an action frame.

It should be noted that the above-mentioned embodiment proposes that the second frame and/or the third frame may be one of the beacon frame, the probe response frame, the multi-link probe response frame, the association request frame, the reassociation request frame, the association response frame, the reassociation response frame, the authentication frame, or the action frame. For detailed descriptions, reference may be made to the description in the information sending method provided in this embodiment of this application, and details are not provided herein.

In some embodiments, the second frame and/or the third frame include a first field, and the non-Wi-Fi signal characteristic capability information is located in the first field. The first field is one of the following: a neighbor report (NR) field, a reduced neighbor report (RNR) field, or a multiple basic service set identifier (MBSSID) field.

It should be noted that the above-mentioned embodiment proposes that the second frame and/or the third frame include the first field, and the first field is the NR field, the RNR field, or the MBSSID field. For detailed descriptions, reference may be made to the description in the information sending method provided in this embodiment of this application, and details are not provided herein.

In some embodiments, before the second device receives the first frame sent by the first device, the method further includes: sending, by the second device, a fourth frame to the first device, where the fourth frame is configured to instruct the first device to collect the characteristic information of the non-Wi-Fi signal.

The fourth frame carries at least one of the following information: a receiving terminal MAC address, collection duration information, delay boundary information, collection mode information, received signal strength information, operating class information, channel number information, type information, or name information.

It should be noted that the above-mentioned embodiment proposes that the second device sends the fourth frame to the first device to instruct the first device to collect the characteristic information of the non-Wi-Fi signal. For detailed descriptions, reference may be made to the description in the information sending method provided in this embodiment of this application, and details are not provided herein.

In some embodiments, after the second device receives the first frame sent by the first device, the method further includes: forwarding, by the second device, the characteristic information of the non-Wi-Fi signal received from the first device to a fourth device.

It should be understood that after receiving the first frame carrying the characteristic information of the non-Wi-Fi signal sent by the first device, the second device may select to forward the received characteristic information of the non-Wi-Fi signal to the fourth device, so that the fourth device may obtain the characteristic information of the non-Wi-Fi signal collected by the first device, thereby achieving sharing of the characteristic information of the non-Wi-Fi signal among a plurality of wireless communication devices, allowing the device to perform the channel configuration related operations according to the characteristic information of the non-Wi-Fi signal collected by the device and other devices, and thus reducing interference of the non-Wi-Fi signal to a Wi-Fi signal.

In some embodiments, the fourth device is an access point (AP) device or a station (STA) device.

In some embodiments, the channel configuration related operations include at least one of the following:
a channel switching operation;
an operating channel selecting operation;
a direct-link channel selecting operation;
a dynamic frequency selection channel operation;
a preamble masking channel configuration operation; or
an energy detection threshold value configuration operation.

It should be noted that the above-mentioned embodiment describes specific channel configuration related operations, including: switching channels, selecting operating channels, selecting direct-link channels, dynamic frequency selection for channels, preamble masking channels, and configuring energy detection threshold values. For detailed descriptions, reference may be made to the description in the information sending method provided in this embodiment of this application, and details are not provided herein.

In some embodiments, the first device is an access point (AP) device or a station (STA) device; and the second device is an access point (AP) device or a station (STA) device.

It should be noted that the above-mentioned embodiment describes device types of the first device and the second device. For detailed descriptions, reference may be made to the description in the information sending method provided in this embodiment of this application, and details are not provided herein.

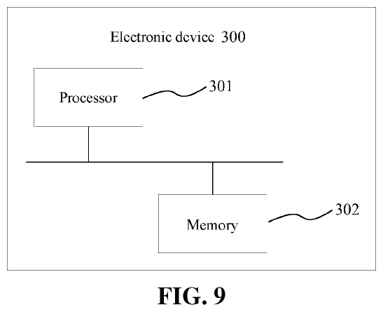

Referring to FIG. 9, an embodiment of this application further provides an electronic device. The electronic device 300 includes, but is not limited to: at least one processor 301 and at least one memory 302, configured to store at least one program. The at least one program, when executed by the at least one processor 301, causes the information sending method described in any above-mentioned embodiment to be performed, or the information receiving method in any above-mentioned embodiment to be performed.

It should be understood that the processor 301 and the memory 302 may be connected through a bus or other methods.

It should be understood that the processor 301 may be a central processing unit (CPU). The processor may also be another general-purpose processor, a digital signal processor (DSP), an application specific integrated circuit (ASIC), a field programmable gate array (FPGA) or another programmable logic device, a discrete gate or transistor logic device, a discrete hardware component, etc. The general-purpose processor may be a microprocessor, or any conventional processor, etc. Alternatively, the processor 301 adopts one or more integrated circuits to execute related programs, thereby implementing the technical solutions provided by the embodiments of this application.

The memory 302, as a non-transitory computer-readable storage medium, may be configured to store non-transitory software programs and non-transitory computer-executable programs, such as the path establishing method performed on an electronic device side described in any embodiment of this application. The processor 301 implements the information sending method described in any above-mentioned embodiment, or the information receiving method in any above-mentioned embodiment by running the non-transitory software programs and instructions stored in the memory 302.

The memory 302 may include a program storage area and a data storage area. The program storage area may store an operating system and an application program required by at least one function. The data storage area may store data for performing the above-mentioned information sending method or the above-mentioned information receiving method. In addition, the memory 302 may include a high-speed random access memory, and may also include a non-transitory memory, such as at least one magnetic memory device, flash memory, or other non-transitory solid-state memories.

In some implementations, the memory 302 optionally includes memories remotely disposed relative to the processor 301. These remote memories may be connected to the processor 301 through a network. The examples of the above-mentioned network include, but are not limited to, an Internet, an intranet, a local area network, a mobile communication network, and a combination thereof.

The non-transitory software programs and instructions required to implement the above-mentioned path establishing method are stored in the memory 302, and the non-transitory software programs and instructions, when executed by the one or more processors 301, cause the information sending method described in any above-mentioned embodiment to be performed, or the information receiving method in any above-mentioned embodiment to be performed.

An embodiment of this application further provides a computer-readable storage medium, having a computer program stored thereon that, when executed by a processor, causes the information sending method described in any above-mentioned embodiment to be implemented, or the information receiving method in any above-mentioned embodiment to be implemented.

The computer storage medium according to this embodiment of this application may adopt any combination of one or more computer-readable media. The computer-readable medium may be a computer-readable signal medium or a computer-readable storage medium. The computer-readable storage medium may be, for example but not limited to, electric, magnetic, optical, electromagnetic, infrared, or semiconductor systems, apparatuses, or devices, or any combination thereof. More specific examples (non-exhaustive) of the computer-readable storage medium include: an electrical connection with one or more wires, a portable computer disk, a hard drive, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the above. In the document, the computer-readable storage medium may be any tangible medium including or storing a program, and the program may be for use by or for use in conjunction with an instruction execution system, apparatus, or device.

The computer-readable signal medium may include data signals propagated in a base band or propagated as a part of a carrier wave, carrying computer-readable program code. The propagated data signal may take various forms, including but not limited to, an electromagnetic signal, an optical signal, or any suitable combination of the above. The computer-readable signal medium may also be any computer-readable medium except the computer-readable storage medium. The computer-readable medium may send, propagate, or transmit programs for use by or for use in conjunction with the instruction execution system, apparatus, or device.

The program code included in the computer-readable medium may be transmitted by any proper medium, including but not limited to wireless, a wire, an optical cable, radio frequency (RF), etc., or any suitable combination of the above.

Computer program code for performing operations of this application may be written in one or more programming languages or a combination thereof, where the programming languages include object-oriented programming languages, such as Java, Smalltalk, and C++, and further include conventional procedural programming languages, such as “C” language or similar programming languages. The program code may be completely executed on a computer of a user, partially executed on a computer of a user, executed as a standalone software package, partially executed on a computer of a user and partially executed on a remote computer, or completely executed on a remote computer or server. In a case of the remote computer, the remote computer may be connected to the computer of the user through any kind of network, including a local area network (LAN) or a wide area network (WAN), or may be connected to an external computer (e.g., connected through the Internet with an Internet service provider).

An embodiment of this application further provides a computer program product, having program instructions stored thereon. The program instructions, when running on a computer device, cause the computer device to implement the information sending method described in any above-mentioned embodiment, or the information receiving method in any above-mentioned embodiment.

The above provides specific descriptions of preferred embodiments of this application, but this application is not limited to the above-mentioned implementations. Those skilled in the art may also make various equivalent transformations or substitutions without departing from the spirit and share conditions of this application, and these equivalent transformations or substitutions all fall within the scope defined by this application.

1. An information sending method, comprising:
acquiring, by a first device, characteristic information of a non-Wi-Fi signal; and
sending, by the first device, a first frame to a second device, the first frame carrying the characteristic information of the non-Wi-Fi signal to cause the second device to perform channel configuration related operations according to the characteristic information of the non-Wi-Fi signal.

2. The method of claim 1, wherein the characteristic information of the non-Wi-Fi signal comprises at least one of: time domain characteristic information, frequency domain characteristic information, or non-Wi-Fi signal type information, wherein
the time domain characteristic information comprises at least one of: signal period characteristic information or signal duration information;
the frequency domain characteristic information comprises at least one of: signal transmit power information, received signal strength information, signal operating class information, signal operating channel number information, number information about surrounding channels affected by a signal, or signal bandwidth information; and
the non-Wi-Fi signal type information comprises at least one of: signal type information or signal name information.

3. The method of claim 1, wherein the first frame is one of: a beacon frame, a probe request frame, a probe response frame, a multi-link probe request frame, a multi-link probe response frame, an association request frame, an association response frame, a reassociation request frame, a reassociation response frame, a de-association frame, an authentication frame, a de-authentication frame, or an action frame.

4. The method of claim 1, further comprising at least one of:
sending, by the first device, a second frame to the second device, the second frame carrying non-Wi-Fi signal characteristic capability information of the first device; or
receiving, by the first device, a third frame sent by the second device, the third frame carrying non-Wi-Fi signal characteristic capability information of the second device.

5. The method of claim 4, wherein at least one of the second frame or the third frame is one of: a beacon frame, a probe request frame, a probe response frame, a multi-link probe request frame, a multi-link probe response frame, an association request frame, an association response frame, a reassociation request frame, a reassociation response frame, a de-association frame, an authentication frame, a de-authentication frame, or an action frame.

6. The method of claim 5, wherein at least one of the second frame or the third frame comprises a first field, the non-Wi-Fi signal characteristic capability information is located in the first field, and the first field is one of: a neighbor report (NR) field, a reduced neighbor report (RNR) field, or a multiple basic service set identifier (MBSSID) field.

7. The method of claim 1, wherein before sending, by the first device, the first frame to the second device, the method further comprises:
receiving, by the first device, a fourth frame sent by the second device, wherein the fourth frame is configured to instruct the first device to collect the characteristic information of the non-Wi-Fi signal; and
wherein the fourth frame carries at least one of: a receiving terminal MAC address, collection duration information, delay boundary information, collection mode information, received signal strength information, operating class information, channel number information, type information, or name information.

8. The method of claim 1, wherein acquiring, by the first device, the characteristic information of the non-Wi-Fi signal comprises at least one of:
acquiring characteristic information of a non-Wi-Fi signal that is locally configured; or
acquiring characteristic information of a non-Wi-Fi signal that is received from a third device.

9. The method of claim 8, wherein the characteristic information of the non-Wi-Fi signal that is locally configured is acquired by at least one of:
acquiring the characteristic information of the non-Wi-Fi signal through spectrum scanning; or
acquiring the characteristic information of the non-Wi-Fi signal according to a local non-Wi-Fi service.

10. The method of claim 8, wherein the third device is an access point (AP) device or a station (STA) device.

11. The method of claim 8, wherein after acquiring the characteristic information of the non-Wi-Fi signal, the method further comprises:
performing channel configuration related operations according to the characteristic information of the non-Wi-Fi signal,
wherein the channel configuration related operations comprise at least one of:
a channel switching operation;
an operating channel selecting operation;
a direct-link channel selecting operation;
a dynamic frequency selection channel operation;
a preamble masking channel configuration operation; or
an energy detection threshold value configuration operation.

12. The method of to claim 1, wherein the first device is an access point (AP) device or a station (STA) device; and the second device is an access point (AP) device or a station (STA) device.

13. An information receiving method, comprising:
receiving, by a second device, a first frame sent by a first device, the first frame carrying characteristic information of a non-Wi-Fi signal; and
performing channel configuration related operations according to the characteristic information of the non-Wi-Fi signal.

14. The method of claim 13, wherein the characteristic information of the non-Wi-Fi signal comprises at least one of: time domain characteristic information, frequency domain characteristic information, or non-Wi-Fi signal type information, wherein
the time domain characteristic information comprises at least one of: signal period characteristic information or signal duration information;
the frequency domain characteristic information comprises at least one of: signal transmit power information, received signal strength information, signal operating channel class information, signal operating channel number information, number information about surrounding channels affected by a signal, or signal bandwidth information; and
the non-Wi-Fi signal type information comprises at least one of: signal type information or signal name information.

15. The method of claim 13, wherein the first frame is one of: a beacon frame, a probe request frame, a probe response frame, a multi-link probe request frame, a multi-link probe response frame, an association request frame, an association response frame, a reassociation request frame, a reassociation response frame, a de-association frame, an authentication frame, a de-authentication frame, or an action frame.

16. The method of claim 13, wherein after receiving, by the second device, the first frame sent by the first device, the method further comprises:
forwarding, by the second device, the characteristic information of the non-Wi-Fi signal received from the first device to a fourth device.

17. The method of claim 16, wherein the fourth device is an access point (AP) device or a station (STA) device.

18. The method of claim 13, wherein the channel configuration related operations comprise at least one of:
a channel switching operation;
an operating channel selecting operation;
a direct-link channel selecting operation;
a dynamic frequency selection channel operation;
a preamble masking channel configuration operation; or
an energy detection threshold value configuration operation.

19. The method of claim 13, wherein the first device is an access point (AP) device or a station (STA) device; and the second device is an access point (AP) device or a station (STA) device.

20. An electronic device, comprising:
one or more processors; and
a memory, having one or more programs stored thereon, the one or more programs, when executed by the one or more processors, causing the one or more processors to implement:
acquiring, by a first device, characteristic information of a non-Wi-Fi signal; and
sending, by the first device, a first frame to a second device, the first frame carrying the characteristic information of the non-Wi-Fi signal to cause the second device to perform channel configuration related operations according to the characteristic information of the non-Wi-Fi signal.
